(19) United States
(12) Patent Application Publication
(10) Pub. No.: US 2010/0266058 A1
(43) Pub. Date: Oct. 21, 2010

(54) OFDM TRANSMISSION APPARATUS, OFDM RECEIVING APPARATUS AND INTERLEAVING METHOD

(76) Inventor: Youhei Murakami, Kawasaki-shi (JP)

Correspondence Address: MORRISON & FOERSTER LLP, 12531 HIGH BLUFF DRIVE, SUITE 100, SAN DIEGO, CA, 92130-2040, US

(21) Appl. No.: 12/671,499

(22) PCT Filed: Jul. 30, 2008
(86) PCT No.: PCT/JP2008/063655

§ 371 Date: Jul. 1, 2010

(30) Foreign Application Priority Data
Jul. 30, 2007 (JP) 2007-197380

(51) Int. Cl. H04L 27/28; H04L 27/00

(52) U.S. Cl. 375/260; 375/295

(57) ABSTRACT

In order to provide a simpler interleaving operation of an OFDM operation than conventional techniques, an OFDM transmission apparatus which transmits transmission data after conducting OFDM (Orthogonal Frequency Division Multiplexing) operation, includes an interleave portion which, in a step before a serial/parallel conversion for a carrier modulation, the transmission data is randomized based on a random number generated by using a predetermined random number generation method.

### TECHNICAL FIELD

The present application relates to an OFDM transmission apparatus, an OFDM receiving apparatus and an interleaving method.

Priority is claimed on Japanese Patent Application No. 2007-197380, filed Jul. 30, 2007, the content of which is incorporated herein by reference.

### BACKGROUND ART

In the Patent Document 1, a digital modulation apparatus/demodulation apparatus and corresponding methods are disclosed that use orthogonal frequency division multiplexing (OFDM) as a modulation method and that, by conducting an interleaving operation, reduce deterioration of communication performance caused by, for example, fading.

This digital modulation/demodulation apparatus has a constitution including: a mapper which conducts a grouping operation on input data arranged in time sequence, selects a time series constituted from multiple symbols in accordance with the obtained groups and conducts a mapping operation on the obtained groups; a serial-parallel converter which rearranges time series output from the mapper in time sequence so as to be parallel; an interleaver which, based on a permutation rule, conducts an interleaving operation on an order of symbols of the time series rearranged in parallel by the serial-parallel converter; an inverse distribute Fourier transformer which converts parallely arranged and interleaved time series output from the interleaver to multiplexed and modulated signals; and a parallel-serial converter which converts multiplexed and modulated signals that are arranged in parallel and output from the inverse distribute Fourier transformer to signals arranged in time sequence.

The above-described interleaver conducts the interleaving operation in a frequency direction, a time direction and a space direction.

Here, in the above-described conventional technique, an interleaving operation is conducted in a frequency direction, a time direction and a space direction. However, in the above-described conventional technique, interleaving operations in a frequency direction, a time direction and a space direction are independent interleaving operations. Therefore, in the above-described conventional technique, a dedicated computer program is necessary for each of the interleaving operations. Due to this, in the above-described conventional technique, interleaving operations are complex.

### [Patent Document 1] Japanese Patent Application, First Publication No. 2006-295756

### DISCLOSURE OF INVENTION

The present invention was conceived in order to solve the above-described problems and has an object to provide a simpler interleaving operation of the OFDM operation than the conventional techniques.

In order to achieve the above-described object, the present invention provides, for example, the following aspects.

A first aspect is an OFDM transmission apparatus which transmits transmission data after conducting OFDM (Orthogonal Frequency Division Multiplexing) operation, including an interleave portion which, in a step before a serial/parallel conversion for a carrier modulation, the transmission data is randomized based on a random number generated by using a predetermined random number generation method.

A second aspect is an OFDM transmission apparatus of the above-described first aspect, wherein the random number generation method is a mixed congruential method.

A third aspect is an OFDM transmission apparatus of the above-described first or second aspect, wherein the interleave portion randomizes the transmission data based on information depending on both a modulation class used for the carrier modulation and a number of symbols.

A fourth aspect is an OFDM receiving apparatus including a deinterleave portion which corresponds to an interleave portion of an OFDM transmission apparatus of one of the above-described first-third aspects, and which receives transmission signals from the OFDM transmission apparatus.

A fifth aspect is an OFDM transmission apparatus of one of the above-described first-third aspects, wherein input parameters of the random number generation method include a symbol number.

A fourth aspect is an OFDM receiving apparatus including a deinterleave portion which corresponds to an interleave portion of an OFDM transmission apparatus of one of the above-described first-third aspects, and the OFDM receiving apparatus receives transmission signals from the OFDM transmission apparatus.

In addition, a seventh aspect is an interleave method. This is an interleave method of transmission data applied to a case in which OFDM (Orthogonal Frequency Division Multiplexing) operation is conducted before transmitting the transmission data, and in the interleave method, before a serial/parallel conversion for a carrier modulation, the transmission data is randomized based on a random number generated by using a predetermined random number generation method.

In accordance with the above-described aspects, an interleaving portion is provided which, in a step before a serial/parallel conversion for a carrier modulation, transmission data is randomized based on a random number generated by using a predetermined random number generation method, and it is possible to achieve a simpler interleaving operation than the conventional technique in which an interleaving operation is conducted on the transmission data after the serial/parallel conversion.

In general, in an interleaving operation of conventional OFDM operations, a bit interleaving operation is conducted after a serial/parallel conversion of the transmission data, and/or a time interleaving operation and frequency interleaving operation are conducted after a layer multiplexing operation on signals on which a carrier modulation operation has been conducted by the above-described serial/parallel conversion. However, these bit interleaving operations, time interleaving operations and frequency interleaving operations are independent interleaving operations, and a dedicated computer program is necessary for each interleaving operation.

However, in accordance with the above-described aspects, the transmission data is randomized based on a random number before a step of conducting serial/parallel conversion for carrier modulation. Therefore, it is possible to integrally conduct an interleaving operation by the interleaving portion that is equivalent to the above-described conventional interleaving operations. Therefore, it is possible to provide a simple computer program for conducting the interleaving operations, and it is possible to save resources, for example, memory necessary for conducting interleaving operations.

### BRIEF DESCRIPTION OF THE DRAWINGS

FIG. 1 is a drawing showing an outline constitution of a wireless communication system of one embodiment constituted from a base station A and a mobile terminal B.

FIG. 2 is a block diagram of the base station A of one embodiment.

FIG. 3 is a flowchart showing an interleaving operation of the base station A of one embodiment.

FIG. 4 is a drawing showing a modulation class table of the base station A of one embodiment.

FIG. 5 is a drawing showing a permutation method between bit arrays of an interleaving operation based on a pseudo-random number in the base station A of one embodiment.

### DESCRIPTION OF THE REFERENCE SYMBOLS

A . . . base station

B . . . mobile terminal

1 . . . OFDM signal transmission portion

1a . . . CRC code appending portion

1b . . . error correction code appending portion

1c . . . interleaving portion

1d . . . serial/parallel conversion portion

1e . . . subcarrier modulation portion

1f . . . inverse Fourier transformation portion

1g . . . guard interval insertion portion

1h . . . wireless signal transmission portion

2 . . . OFDM signal receiving portion

2a . . . wireless signal receiving portion

2b . . . guard interval removing portion

2c . . . Fourier transformation portion

2d . . . subcarrier demodulation portion

2e . . . parallel/serial conversion portion

2f . . . deinterleave portion

2g . . . error correction portion

2h . . . CRC calculation portion

3 . . . control portion

### BEST MODE FOR CARRYING OUT THE INVENTION

Hereinafter, in reference to the drawings, preferable embodiments are described. However, the present invention is not limited by the following embodiments, and for example, it is possible to combine constitutional elements of the following embodiments in an appropriate manner. One embodiment relates to a base station which communicates with a mobile terminal by using an OFDM method.

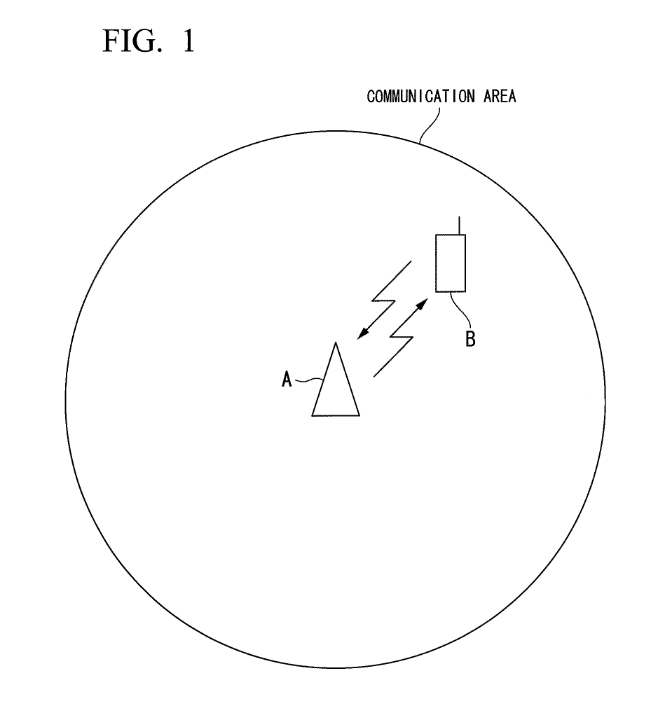

FIG. 1 is a drawing showing an outline constitution of a wireless communication system of this embodiment constituted from a base station A and a mobile terminal B. As shown in FIG. 1, the wireless communication system has a constitution including the base station A and the mobile terminal B.

The base station A, by transmitting/receiving communication signals to/from the mobile terminal B in accordance with Orthogonal Frequency Division Multiplexing (OFDM) as a modulation method, conducts a circuit switched communication or packet communication. Orthogonal Frequency Division Multiplexing (OFDM) is a type of multicarrier communication which communicates by using multiple subcarriers having different frequencies. Modulation methods of subcarriers applied to Orthogonal Frequency Division Multiplexing are a digital amplitude modulation and/or digital phase modulation.

The mobile terminal B, by transmitting/receiving communication signals to/from the base station A in accordance with the above-described OFDM method, conducts a circuit switched communication or packet communication.

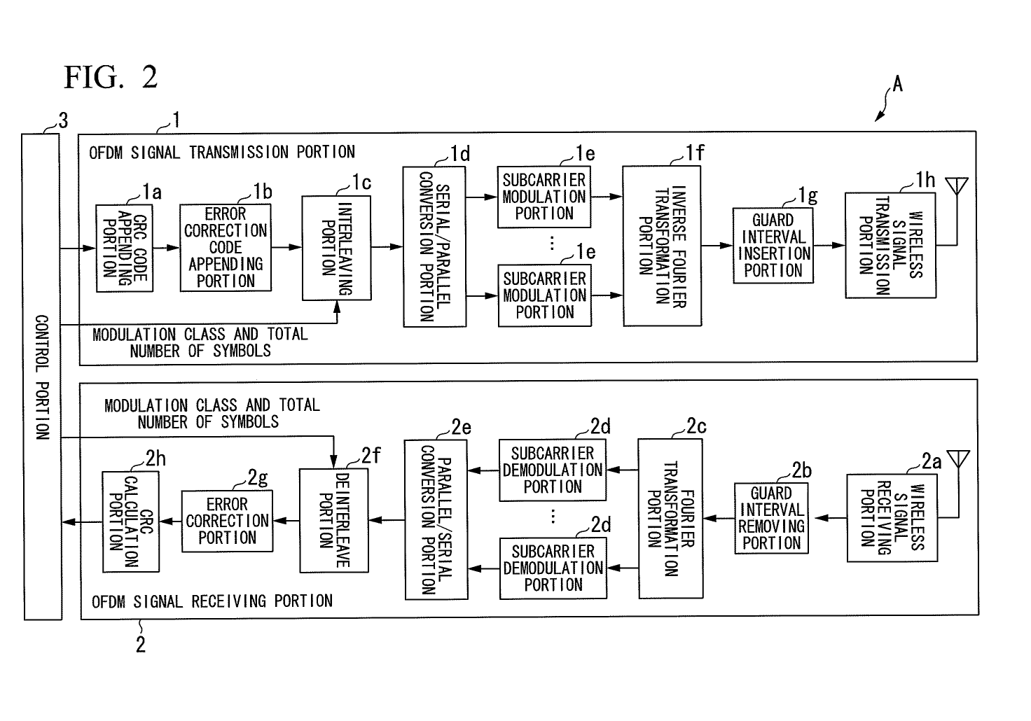

In the following, in reference to a functional block diagram shown in FIG. 2, a substantial and functional constitution of the above-described base station A is explained.

The base station A includes an OFDM signal transmission portion 1, OFDM signal receiving portion 2 and control portion 3. The OFDM signal transmission portion 1 has a constitution including a CRC code appending portion 1a, an error correction code appending portion 1b, an interleaving portion 1c, a serial/parallel conversion portion 1d, subcarrier modulation portions 1e, an inverse Fourier transformation portion 1f, a guard interval insertion portion 1g, and a wireless signal transmission portion 1h. The OFDM signal receiving portion 2 has a constitution including a wireless signal receiving portion 2a, a guard interval removing portion 2b, a Fourier transformation portion 2c, subcarrier demodulation portions 2d, a parallel/serial conversion portion 2e, a deinterleave portion 2f, an error correction portion 2g, and a CRC calculation portion 2h.

Based on a command input from the control portion 3, the CRC code appending portion 1a appends a CRC code, which is redundant information and which is used for error detection, to the transmission data (control signals or data signals) input from the control portion 3 and outputs the transmission data to the error correction code appending portion 1b.

Based on a command input from the control portion 3, the error correction code appending portion 1b appends error correction codes, for example, convolutional codes to bit arrays of the transmission data input form the CRC code appending portion 1a and outputs the bit arrays to the interleave portion 1c.

Based on both a modulation class and a total number of symbols input from the control portion 3, the interleave portion 1c conducts a permutation of the bit arrays input from the error correction code appending portion 1b in accordance with a predetermined rule and outputs the bit arrays to the serial/parallel conversion portion 1d.

Controlled by the control portion 3, the serial/parallel conversion portion 1d divides the bit arrays input from the interleave portion 1c in a bitwise manner while assigning the divided bits to the corresponding subcarriers and outputs the divided bit arrays to the corresponding subcarrier conversion portions 1e.

The same number of the subcarrier conversion portions 1e is provided as the subcarriers. The subcarrier modulation portion 1e, based on the subcarriers, conducts a digital modulation operation on the bit arrays divided so as to correspond to the subcarriers and output the modulated signals to the inverse Fourier transformation portion 1f. It should be noted that each of the subcarrier modulation portions 1e conducts a digital modulation based on a modulation method specified by the control portion 3, for example, BPSK(Binary Phase Shift Keying), PSK(Quadrature Phase Shift Keying), 16 QAM(Quadrature Amplitude Modulation) and 64 QAM.

The inverse Fourier transformation portion 1f generates OFDM signals by conducting an orthogonal multiplexing operation on the modulated signals input from each of the subcarrier modulation portions 1e in accordance with the inverse Fourier transformation and outputs the OFDM signals to the guard interval insertion portion 1g.

The guard interval insertion portion 1g inserts guard intervals into the OFDM signals input from the inverse Fourier transformation portion 1f and outputs the OFDM signals to the wireless signal transmission portion 1h.

The wireless signal transmission portion 1h converts the OFDM signals input from the guard interval insertion portion 1g that are analog signals to digital signals. The wireless signal transmission portion 1h converts the OFDM signals after conversion to the digital signals that are in IF frequency band to RF frequency band. The wireless signal transmission portion 1h amplifies the OFDM signals after conversion to the RF frequency band so as to be a predetermined transmission output level by using, for example, a power amplifier, and transmits the OFDM signals to the mobile terminal B via an antenna.

The wireless signal receiving portion 2a receives OFDM signals from the mobile terminal B via the antenna and converts the OFDM signals that are in the RF frequency band to the IF frequency band. The wireless signal receiving portion 2a amplifies the OFDM signals in the IF frequency band by using, for example, a low noise amplifier. The wireless signal receiving portion 2a converts the amplified OFDM signals that are analog signals to digital signals by using an A/D converter and outputs the OFDM signals to the guard interval removing portion 2b.

The guard interval removing portion 2b removes guard intervals from the OFDM signals input from the wireless signal receiving portion 2a and outputs the OFDM signals to the Fourier transformation portion 2c.

The Fourier transformation portion 2c calculates the modulated signals corresponding to the subcarriers by conducting Fourier transformation on the OFDM signals input from the guard interval removing portion 2b and outputs the modulated signals to corresponding subcarrier demodulation portions 2d.

The same number of the subcarrier demodulation portions 2d are provided as a number of subcarriers. The subcarrier demodulation portion 2d, on the modulated signals, conducts both phase correction/frequency correction/power correction operations and digital demodulation operation based on the subcarrier, converts the modulated signals to the data sequences of the received data and output the data sequences to the parallel/serial conversion portion 2e.

Based on commands from the control portion 3, the parallel/serial conversion portion 2e combines the multiple data sequences input from the subcarrier demodulation portions 2d into one data sequence and output the data sequence to the deinterleave portion 2f.

Based on the modulation class and total number of symbols input from the control portion 3, in accordance with a predetermined rule, the deinterleave portion 2f corrects or rearranges an order of the data sequence in which the order is changed by interleaving at the mobile terminal B so as to be the original order and outputs the data sequence to the error correction portion 2g.

In accordance with a controlling operation by the control portion 3, by applying a soft-decision, the error correction portion 2g conducts an error correction operation on the data sequence input from the deinterleave portion 2f and outputs the data sequence to the CRC calculation portion 2h.

In accordance with a controlling operation by the control portion 3, based on a CRC code for error detection attached to the data sequence, the CRC calculation portion 2h conducts a CRC calculation and outputs the CRC calculation results with the data sequence to the control portion 3.

The control portion 3 has a constitution including a CPU (Central Processing Unit), an internal memory constituted from ROM (Read Only Memory) and RAM (Random Access Memory), the OFDM signal transmission portion 1, the OFDM signal receiving portion 2, interface circuits which conduct input/output operations regarding various signals, and the like. The control portion 3 controls overall operations of the base station A based on control programs stored in the ROM and various signals received by the OFDM signal receiving portion 2. It should be noted that if the CRC calculation results input from the CRC calculation portion 2h indicate “OK”, the control portion 3 conducts predetermined operations based on commands included in the various signals constituted from the data sequences input from the CRC calculation portion 2h. If the CRC calculation results input from the CRC calculation portion 2h indicate “NG”, the control portion 3 requests the OFDM signal transmission portion 1 to transmit a retransmission request.

In the following explanation, an interleaving operation of the base station A having the above-described constitution is explained.

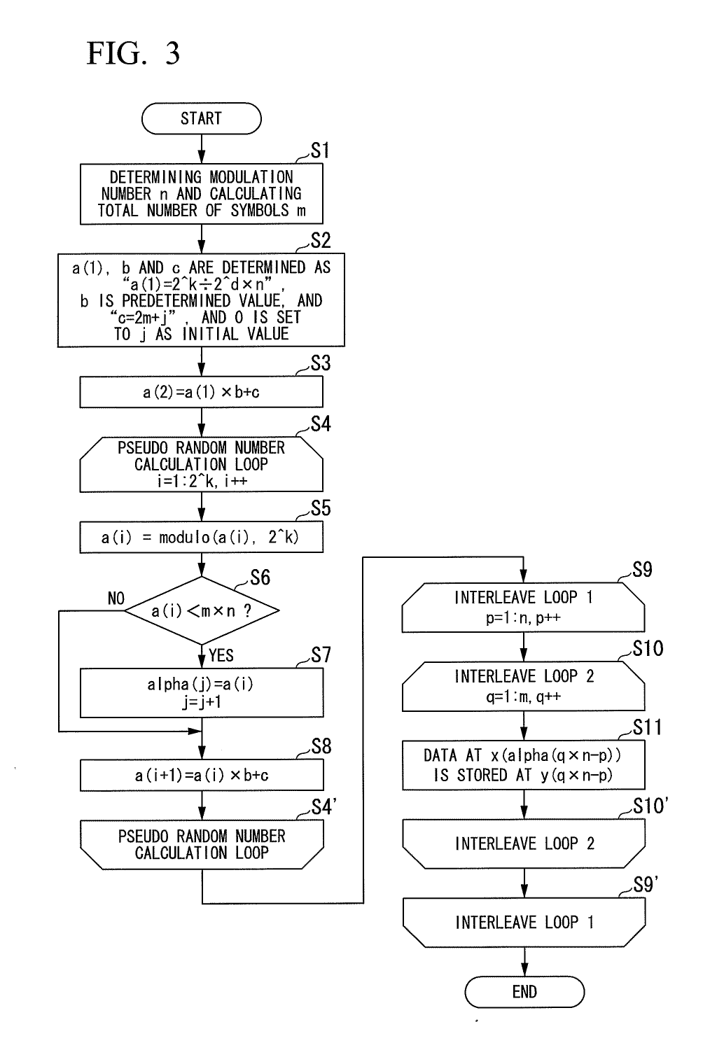

FIG. 3 is a flowchart showing an interleaving operation of the base station A.

In general, a conventional OFDM transmission apparatus which transmits OFDM signals has an object in which, on a receiving side of the OFDM signals, it is possible to correct errors of the signals based on error correction codes. Therefore, in the conventional OFDM transmission apparatus, a technique called interleaving is used which converts burst errors of the signals due to fading on transmission paths to random errors. There are various interleaving methods, for example, a frequency interleaving which conducts an interleaving operation on the data along a frequency of the signals, a time interleaving which conducts interleaving operation on the data along a direction of time. The conventional OFDM apparatus which outputs OFDM signals recognizes such interleaving operations as independent operations and separately conducts such interleaving operations.

By using a simple interleaving operation of the base station A of this embodiment, it is possible to achieve the same advantage as an operation in which multiple and different interleaving operations are conducted.

First, when the base station A transmits data signals, for example, packet data to the mobile terminal B, the control portion 3 outputs bit arrays of the data signals to the CRC code appending portion 1a. The CRC code appending portion 1a appends CRC codes to the bit arrays and outputs the bit arrays to the error correction code appending portion 1b. The error correction code appending portion 1b inputs the bit arrays, appends error correction codes to the bit arrays and outputs the bit arrays to the interleave portion 1c.

In advance of an interleaving operation of the interleave portion 1c, the control portion 3 determines a modulation class n based on the modulation method of the subcarriers of the OFDM signals, and calculates a total symbol number m based on both a number of sub-channels and a number of symbols included in one sub-channel (Step 1).

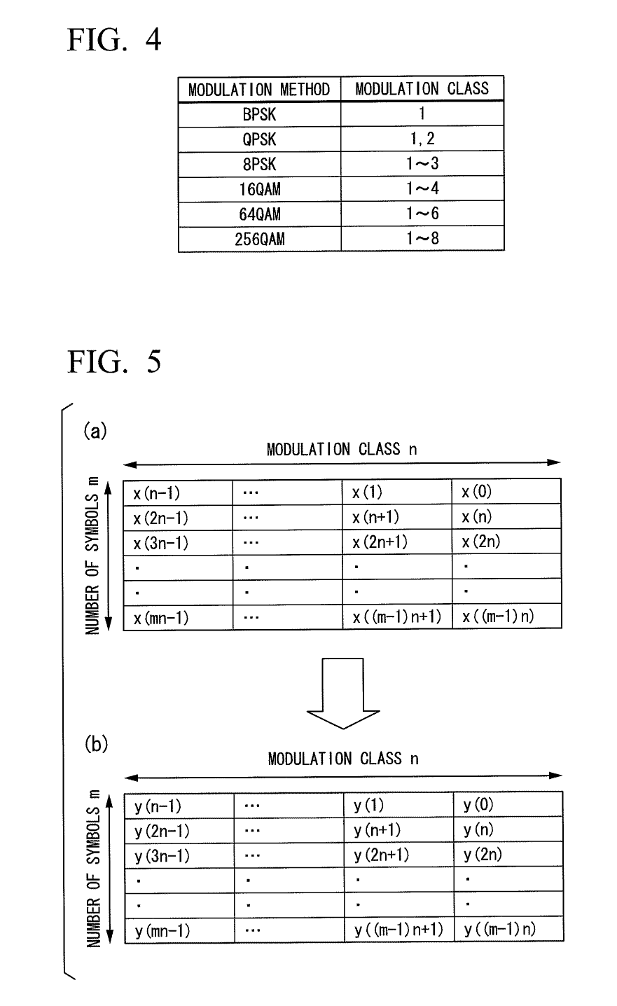

The above-described modulation class is explained in reference to FIG. 4 showing a modulation class table. As shown in FIG. 4, a modulation class corresponding to each modulation method is predetermined, and the modulation class table is stored in a ROM of the control portion 3 beforehand. In Step 1, the control portion 3 determines a modulation class corresponding to a modulation method of a sub-channel based on the modulation class table. In addition, the determined modulation class indicates a number of bits that constitute one symbol.

The control portion 3 outputs both m which is a total number of symbols and n which is a modulation class to the interleave portion 1c.

The interleave portion 1c applies both the total number of symbols m and the modulation class n as parameters to a following equation (1) of a mixed congruential method and calculates a pseudo random number.

a(i+1)=a(i)×b+c (1)

(i=1, 2, 3 . . . n−1)

It should be noted that, based on the above equation (1), by using predetermined constants b and c, the interleave portion 1c assigns a(1) to a(i) and calculates a(i+1), that is, a(2) as a pseudo random number. In a next operation, the interleave portion 1c assigns a(2) to a(i) and calculates a(i+1), that is, a(3) as a pseudo random number. That is to say, by using the above equation (1) and repeatedly conducting calculations, it is possible to calculate multiple pseudo random numbers. It should be noted that b is a predetermined value that is determined by the interleave portion 1c, and it is possible to calculate a(1) and c in accordance with the following method.

The interleave portion 1c calculates an integer “k” which is the minimum integer that satisies “m×n<2̂k” (2̂k means 2^{k}). For example, in a case in which the total number of symbols m is 300 while the modulation class n is 2, k is 10 which is the minimum number among integers that satisfy “300×2<2̂k”.

The interleave portion 1c calculates a(1) by assigning k and the modulation class n as parameters to an equation shown below. The interleave portion 1c calculates the constant c by assigning the total number of symbols m to an equation (3) shown below. The interleave portion 1c determines a value as a predetermined value assigned to the constant b and assigns 0 to a variable j as an initial value (Step S2). It should be noted that the variable j is used in Step S7. Further, a(1) described above is an integer, and “d” of the equation (2) shown below is a value which satisfies 0<d<k (for example, d=4).

a(1)=2̂k÷2̂d×n (2)

c=2m+j (3)

The interleave portion 1c calculates a(2) by assigning a(1) and the constants b and c determined at Step S2 to the above equation (1) (Step S3). The interleave portion 1c conducts operations of a pseudo random number calculation loop shown as Step S4-Step S4′. The pseudo random number calculation loop is repeated while incrementing “i” of the above equation (1) by 1 until when “i” becomes 2̂k. It should be noted that values of m, n, a(i), a(i+1), b, c, k and d are stored in a memory, and the interleave portion 1c conducts calculation operations based on these values stored in the memory.

The interleave portion 1c, first, conducts an operation (4) shown below as operations of the pseudo random number calculation loop of Steps S4-S4′ (Step S5).

a(i)=modulo(a(i), 2̂k (4)

The operation (4) shown above is an operation in which the pseudo random number of a(i) is divided by 2̂k, and a remainder calculated by such a division operation is assigned to a(i).

The interleave portion 1c determines whether or not a(i) calculated in Step 5 is less than a value calculated by multiplying the total number of symbols m by the modulation class n (Step S6). If the determination result of Step S6 is “YES”, the interleave portion 1c assigns a value of a(i) as a pseudo random number to alpha(j) and adds 1 to a value of “j” (Step S7). “j” has an initial value “0” and is incremented by 1 at Step S7 every time the pseudo random number calculation loop of Steps S4-S4′ is repeated, and accordingly, a(i) is assigned to alpha(0), alpha(1), alpha(2), . . . one after another. It should be noted that a value of alpha(j) is stored in the memory.

After Step S7, the interleave portion 1c calculates a(i+1) based on a(i) by using the above equation (1) (Step S8).

If the determination result of Step S6 is “NO”, the interleave portion 1c conducts Step S8 without conducting Step S7.

The interleave portion 1c conducts an interleaving operation on bit arrays of the data signals based on the pseudo random number which is assigned to the alpha(i) at Step S7.

In reference to FIG. 5, a permutation method between bit arrays of the interleaving operation conducted by the interleave portion 1c is explained.

In FIG. 5, (a) shows a memory area in which the bit arrays before the interleaving operation are shown. In FIG. 5, (b) shows a memory area in which the bit arrays are stored after the interleaving operation are shown. In (a) of FIG. 5, along a direction of columns, the bit arrays with the number of symbols m are shown, and along a row direction, the bit arrays with the modulation class n are shown.

In (a) of FIG. 5, each box or lattice indicates the minimum unit of the memory storing the data shown in a bitwise manner that constitutes the bit arrays. “x(0), x(1) . . . x(mn−1)” indicates memory addresses of the memory area. In addition, “y(0), y(1) . . . y(mn−1)” of (b) of FIG. 5 indicates memory addresses of the memory area.

In a interleave loop 1 of Steps S9-S9′, first, the interleave portion 1c assigns “1” to a variable “p” as an initial value. In a interleave loop 2 of Steps S10-S10′, first, the interleave portion 1c assigns “1” to a variable “q” as an initial value.

Based on the variables p and q, the interleave portion 1c calculates a pseudo random number of alpha(q×n−p). Based on this pseudo random number, the interleave portion 1c stores the data which is originally stored in a memory area corresponding to a memory address x(alpha(q×n−p)) shown in (a) of FIG. 5 to a memory area corresponding to a memory address y(q×n−p) shown in (b) of FIG. 5 (Step S11).

The interleave portion 1c increments the variable p by 1 every time an operation of the interleave loop 1 including Steps 9-9′ is conducted and repeatedly conducts the operation of the interleave loop 1 until the variable p equals the modulation class n. The interleave portion 1c increments the variable q by 2 every time an operation of the interleave loop 1 including Steps 10-10′ is conducted and repeatedly conducts the operation of the interleave loop 2 until the variable q equals the total number of symbols m.

Both the interleave loop 1 including Steps S9-S9′ and interleave loop 2 including Steps S10-S10′ are looped operations provided for repeatedly conducting an operation of Step S11 by the interleave portion 1c. Because the interleave portion 1c repeatedly conducts Step S11, all of the data of the bit arrays stored in a memory area shown in (a) of FIG. 5 is stored in a memory area shown in (b) of FIG. 5, and the order of the bit arrays of the data signals are randomized.

As described above, in accordance with this embodiment, before a step in which the serial/parallel conversion portion 1d divides the bit arrays, the interleave portion 1c calculates multiple random numbers based on the above-described equation (1). In this embodiment, a permutation or rearrangement of an order of the bit arrays is conducted based on such random numbers. Therefore, compared to conventional techniques in which an interleaving operation is conducted after a serial/parallel conversion operation on the transmission data, this embodiment can simplify the interleave operation.

In general, in a conventional interleave operation of OFDM modulation, a bit-interleave operation is conducted on the bit arrays of the transmission data after serial/parallel conversion, and/or both a time interleave operation and a frequency interleave operation are conducted on the modulated signals on which a subcarrier modulation is conducted after the serial/parallel conversion. These bit-interleave operation, time interleave operation and frequency interleave operation are independent interleave operations. Therefore, a dedicated computer program is necessary for each interleave operation.

However, in this embodiment, before a step in which a serial/parallel conversion is conducted, the interleave portion 1c randomizes the bit arrays of the transmission data based on the random numbers. Therefore, it is possible to conduct an interleave operation which is equivalent to the above-described three interleave operations and which is conducted by the interleave portion 1c in a consolidated manner. In addition, it is possible to simplify the computer program regarding the interleave operation, and it is possible to save the resources necessary for the interleave operation, for example, a memory resource.

In addition, in this embodiment, it is possible to further save resources because a mixed congruential method is used for calculating random numbers.

One embodiment is explained above; however, the present invention is not limited by the above-described embodiment. For example, it is possible to apply following changes.
(1) In the above-described embodiment, the above-described interleave operation is conducted at the base station; however, this is not a limitation.

For example, the above-described interleave operation can be conducted by a PHS terminal, a cellular phone terminal, or the like that can output or transmit OFDM signals.
(2) In the above-described embodiment, a mixed congruential method is used for calculating random numbers. However, this is not a limitation for the present invention.

For example, it is possible to use, for example, a midsquare method and linear congruential generators to calculate random numbers.

In addition, purposes of the above-described embodiment are not limited to a wireless terminal such as a cellar phone and a PHS and a base station of such wireless terminals.

For example, it is possible to apply the above-described embodiment to transmission/reception of broadcast waves. In accordance with such an application, it is possible to achieve an advantage in which it is possible to simplify an interleave operation of a digital broadcast. In addition, it is possible to apply the above-described embodiment to a data transmission/reception of a wire communication.

### INDUSTRIAL APPLICABILITY

It is possible to provide an OFDM transmission apparatus, OFDM receiving apparatus and an interleave method that can conduct a simpler interleaving operation of the OFDM operation than the conventional techniques.

1. An OFDM transmission apparatus which transmits transmission data after conducting an OFDM (Orthogonal Frequency Division Multiplexing) operation, comprising
an interleave portion which, in a step before a serial/parallel conversion for a carrier modulation, the transmission data is randomized based on a random number generated by using a predetermined random number generation method.

2. An OFDM transmission apparatus according to claim 1, wherein the random number generation method is a mixed congruential method.

3. An OFDM transmission apparatus according to claim 1, wherein the interleave portion randomizes the transmission data based on information depending on both a modulation class used for the carrier modulation and a number of symbols.

4. An OFDM receiving apparatus comprising a deinterleave portion which corresponds to an interleave portion of an OFDM transmission apparatus according to claim 1 and which receives transmission signals from the OFDM transmission apparatus.

5. An interleave method of transmission data that conducts OFDM (Orthogonal Frequency Division Multiplexing) operation before transmitting the transmission data comprising the steps of:
before a serial/parallel conversion for a carrier modulation, randomizing the transmission data based on a random number generated by using a predetermined random number generation method.

6. A wireless transmission apparatus comprising:
an error correction code appending portion which generates bit arrays by appending error correction codes to transmission data and outputs the bit arrays;
an interleave portion which inputs the bit arrays from the error code appending portion, which conducts a permutation of an order of the bit arrays based on random numbers which are generated by using a modulation class and a total number of symbols and which outputs the bit arrays;
a serial/parallel conversion portion which inputs the bit arrays from the interleave portion, which divides the bit arrays in a bitwise manner while assigning the divided bits to corresponding subcarriers and which outputs the divided bits;
a subcarrier modulation portion which inputs the divided bit arrays from the serial/parallel conversion portion, which generates modulated signals by conducting a digital modulation based on the subcarriers and which outputs the modulated signals;
an inverse Fourier transformation portion which inputs the modulated signals from the subcarrier modulation portion, which generates transmission signals by conducting an inverse Fourier transformation and outputs the transmission signals; and
a wireless signal transmission portion which inputs the transmission signals from the inverse Fourier transformation portion, which generates analog signals by conducting a D/A conversion and transmits the analog signals.
